(19) United States
(12) Patent Application Publication
(10) Pub. No.: US 2014/0083334 A1
(43) Pub. Date: Mar. 27, 2014

(54) SULPHUR CEMENT PRE-COMPOSITION AND SULPHUR CEMENT PRODUCT

(71) Applicants: Guy Lode Magda Maria Verbist, Amsterdam (NL); Willem Posthumus, Eindhoven (NL); Catherine Frances Smura, Amsterdam (NL)

(72) Inventors: Guy Lode Magda Maria Verbist, Amsterdam (NL); Willem Posthumus, Eindhoven (NL); Catherine Frances Smura, Amsterdam (NL)

(21) Appl. No.: 14/003,015

(22) PCT Filed: Mar. 14, 2012
(86) PCT No.: PCT/EP2012/054428

§ 371 Date: Oct. 22, 2013

(30) Foreign Application Priority Data
Mar. 14, 2011 (EP) 11158056.9

(51) Int. Cl. C04B 24/16

(52) U.S. Cl. CPC C04B 24/16
USPC 106/806; 106/823

(57) ABSTRACT

A sulphur cement pre-composition, comprising sulphur and an organosilane coupling agent of formula (I); wherein R¹, R² and R³ are independently chosen from alkoxy, acyloxy, acyloxy, alkyl, aryl and halogen, wherein R⁴ is alkyl, wherein n is from 1 to 8, wherein R⁵ is alkyl, alkenyl or aralkyl and wherein p is an integer of at least 1, and wherein the weight ratio of sulphur to organosilane coupling agent is at least 1.

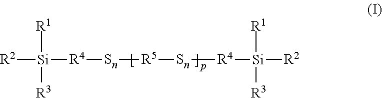

### FIELD OF THE INVENTION

The present invention provides a sulphur cement pre-composition and a sulphur cement product. The invention further provides a process for the preparation of a sulphur cement pre-composition and a process for the preparation of a sulphur cement product.

### BACKGROUND OF THE INVENTION

Sulphur-containing organosilane compounds are used as coupling agents in rubber compounds, and may also be used as adhesion primers for glass and metals. The compounds typically correspond to the general formula:

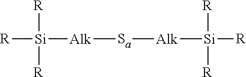

wherein a is an integer from 2 to 10, Alk is an alkyl group and the R groups are independently chosen from alkyl, alkoxy, aryl, aryloxy, acyloxy and halogen groups. The synthesis of such coupling agents is described in GB 1394135 and U.S. Pat. No. 6,294,683.

Such compounds can also be used as coupling agents in sulphur composites. As described in WO 2007/065920, polysulphide-containing coupling agents can reduce the water uptake and improve the mechanical properties of sulphur composites such as sulphur cement. A preferred polysulphide-containing organosilane is bis(3-triethyoxysilylpropyl)tetrasulphide. WO 2010/012601 describes how organosilane coupling agents can be synthesised in the presence of sulphur.

It is desirable to find alternative organosilane coupling agents. In particular, it is desirable to provide organosilane coupling agents with improved solubility in sulphur as the known coupling agents such as bis(3-triethyoxysilylpropyl) tetrasulphide have limited solubility in molten sulphur. Improved solubility may offer benefits when preparing sulphur pre-compositions for use in the manufacture of sulphur composites, and may additionally offer benefits with respect to the properties of sulphur composites.

The present inventors have sought to provide sulphur cement pre-compositions and sulphur cement products wherein use is made of alternative organosilane coupling agents.

### SUMMARY OF THE INVENTION

Accordingly, the present invention provides a sulphur cement pre-composition comprising sulphur and an organosilane coupling agent of formula (I):

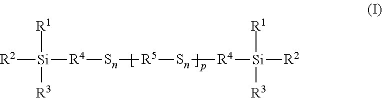

wherein R¹, R² and R³ are independently chosen from alkoxy, acyloxy, aryloxy, alkyl, aryl and halogen, wherein R⁴ is alkyl, wherein n is from 1 to 8, wherein R⁵ is alkyl, alkenyl or aralkyl and wherein p is an integer of at least 1, and wherein the weight ratio of sulphur to organosilane coupling agent is at least 1.

The inventors have found that the organosilane coupling agents of formula (I) have improved solubility in molten sulphur when compared to known organosilane coupling agents such as bis(3-triethyoxysilylpropyl)tetrasulphide.

The sulphur cement pre-composition can be used in a process for the preparation of a sulphur cement product according to the invention. The inventors believe that improved solubility of the coupling agents of formula (I) in sulphur may be advantageous when preparing sulphur cement pre-compositions. Higher solubility may help to increase stability of sulphur cement pre-compositions such that the amount of coupling agent does not decrease as the sulphur cement pre-compositions are subject to aging. Higher solubility may enable the preparation of sulphur cement compositions having higher concentrations of coupling agent and this may enable the skilled person to prepare a sulphur cement product from a lower volume of the sulphur cement pre-composition (and a correspondingly higher volume of non-modified sulphur).

The present invention further provides a sulphur cement product, comprising sulphur, a particulate inorganic material and an organosilane coupling agent of formula (I). The inventors believe that improved solubility of the coupling agents of formula (I) in sulphur may be advantageous when preparing sulphur cement products. It is possible that improved solubility of the coupling agent may enhance the interaction of the sulphur and the particulate inorganic material. Improved interaction may lead to lower viscosity (for a given amount of sulphur), leading to the possibility of using lower sulphur ratios in the sulphur cement products.

The present invention yet further provides a process for the preparation of a sulphur cement pre-composition, comprising admixing sulphur with an organosilane coupling agent of formula (I).

The present invention yet further provides a process for the preparation of a sulphur cement product comprising the steps of:

(a) admixing sulphur with an organosilane coupling agent of formula (I) and with a particulate inorganic material at a temperature at which sulphur is molten to obtain a molten sulphur cement product, and wherein the weight ratio of sulphur to organosilane coupling agent is at least 1; and

(b) solidifying the molten sulphur cement product.

### DETAILED DESCRIPTION OF THE INVENTION

In accordance with the present invention use is made of an organosilane coupling agent of formula (I):

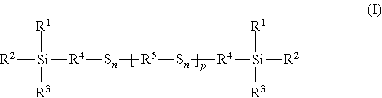

which may be prepared by a process wherein compounds of formula (II), (III) and (IV) are combined:

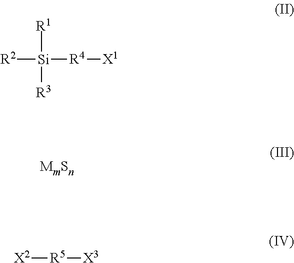

In the processes of the prior art, a compound of formula (IV) is not used during the synthesis of coupling agents. By including the compound of formula (IV) during synthesis of the organosilane coupling agent, the present inventors have incorporated one or more R⁵ groups into the sulphane bridge and have incorporated additional sulphur atoms into the sulphane bridge, thereby increasing the length of the sulphane bridge and increasing the solubility of the coupling agents when compared to coupling agents with shorter sulphane bridges.

R¹, R² and R³ are independently chosen from alkoxy, acyloxy, aryloxy, alkyl, aryl and halogen. Preferably R¹, R² and R³ are independently chosen from alkoxy, acyloxy and aryloxy groups and more preferably, R¹, R² and R³ are independently chosen from alkoxy groups. Most preferably R¹, R² and R³ are all the same and are alkoxy groups. Preferred alkoxy groups are C₁₋₄ alkoxy groups, most preferably ethoxy and methoxy groups.

R⁴ is alkyl, preferably C₁₋₆ alkyl and most preferably C₃ alkyl.

R⁵ is alkyl, alkenyl or aralkyl, preferably C₁₋₆ alkyl or C₁₋₆ alkenyl, more preferably C₁₋₆ alkyl and most preferably C₃₋₄ alkyl.

p is an integer of at least 1. The value of p is usually determined by the ratio of compounds of formula (II), (III) and (IV) that are reacted together. Typically, p is less than 10 and often less than 6.

X¹ is a leaving group chosen from the group consisting of halogen, carboxylate, nitro, azide, thiocyanate, ammonium, phosphonium and sulfonate (e.g. tosyl, triflate, mesyl) and is more preferably halogen. Preferred halogens are chlorine, bromine or iodine, more preferably chlorine or bromine and most preferably chlorine.

In the compound of formula (III), M is a metal atom, a nitrogen-containing cation or a phosphorus-containing cation, m is 1 or 2 and n is from 1 to 8, or M is hydrogen, m is 2 and n is 1. Preferably m is 2. Suitable nitrogen-containing cations are ammonium cations of formula A₄N⁺ wherein A is hydrogen or alkyl. Suitable phosphorus-containing cations are phosphonium cations of formula B₄P⁺ wherein B is hydrogen, alkyl or aryl. M may be a divalent metal ion, e.g. an alkaline earth metal ion such as calcium, but is preferably a monovalent metal ion. Preferably M is an alkali metal ion (more preferably sodium or potassium), m is 2 and n is from 2 to 6, or M is hydrogen, m is 2 and n is 1.

In one embodiment of the invention, the compound of formula (III) may be prepared in situ by reacting a compound of formula MₘS with molten sulphur. For example, Na₂S₄ may be prepared by reacting Na₂S with molten sulphur. Preferably this reaction takes place in an aqueous solution.

X² and X³ are leaving groups independently chosen from the group consisting of halogen, carboxylate, nitro, azide, thiocyanate, ammonium, phosphonium and sulfonate (e.g. tosyl, triflate, mesyl) and are more preferably halogen. Preferred halogens are chlorine, bromine or iodine, more preferably chlorine or bromine and most preferably chlorine. The reactivity of the X² and X³ leaving groups to nucleophilic substitution should be sufficient to react with the compound of formula (III). If X² and X³ are attached to an aralkyl R⁵ group, then X² and X³ are suitably attached to an alkyl carbon, not an aryl carbon. If X² and X³ are attached to an alkyl carbon, then suitably this is not a tertiary alkyl carbon.

The compound of formula (IV) is suitably soluble in organic solvents such that it can dissolve in an organic phase with the compound of formula (II) during the process for preparing the compound of formula (I).

Preferred compounds of formula (IV) include 1,2-dichloropropane and 1,4-dichlorobutane.

Preferably the reaction of compounds of formula (II), (III) and (IV) takes place in the presence of a phase transfer catalyst. For example, the compound of formula (III) may be prepared by the reaction of a compound of formula MₘS with molten sulphur in water, and then this aqueous solution may be mixed with compounds of formula (II) and (IV) in the presence of a phase transfer catalyst. In principle any phase transfer catalysts may be used. Examples of preferred phase transfer catalysts are quaternary ammonium or phosphonium salts. In view of the high costs of phosphonium salts, more preferably the phase transfer catalyst is a tetra-alkyl ammonium salt, wherein at least one alkyl group is a C₃-C₂₀ alkyl group, more preferably a C₄-C₁₂ group, even more preferably a C₄ to C₆ group.

Preferably, the counter ion in the quaternary ammonium or phosphonium salt is a monovalent ion, more preferably bromide. Examples include tetra-butyl ammonium bromide; tetra-octyl ammonium bromide; and cetyl tri-methyl ammonium bromide.

In one embodiment of the process for preparing an organosilane coupling agent in accordance with the present invention, compounds of formula (II), (III) and (IV) are combined in the presence of molten sulphur. Using sulphur as the reaction medium has the advantage that the product of this reaction is the organosilane coupling agent of formula (I) combined with sulphur, and this product is usable directly as a sulphur cement pre-composition. If the process of the invention is carried out in the presence of molten sulphur and particulate inorganic material, then the product is usable directly as a sulphur cement product.

In another embodiment of the process for preparing an organosilane coupling agent in accordance with the present invention, compounds of formula (II), (III) and (IV) are combined in the presence of molten wax. Using wax has the advantage that the organosilane coupling agent of formula (I) is provided as a wax-based pre-composition comprising wax and the organosilane coupling agent of formula (I).

Other solvents such as toluene may be used in the process of the invention for preparing an organosilane coupling agent.

The present invention also provides a sulphur cement pre-composition comprising sulphur and an organosilane coupling agent of formula (I). The sulphur cement pre-composition can be used in a process for the preparation of a sulphur cement product according to the invention.

Preferably, the sulphur cement pre-composition comprises at least 0.01 wt % of the organosilane coupling agent of formula (I), based on the weight of the total composition. More preferably, the sulphur cement pre-composition comprises in the range of from 0.01 to 50 wt %, yet more preferably from 0.01 to 20 wt %, even more preferably from 0.01 to 10 wt % and most preferably 0.01 to 1 wt % of the organosilane coupling agent of formula (I) based on the weight of the total composition. The preferred amount of the organosilane coupling agent of formula (I) is largely determined by the intended use of the sulphur cement pre-composition. For example, if the sulphur cement pre-composition is to be combined with filler and with further sulphur to form a sulphur cement, then the weight percentage of the organosilane coupling agent of formula (I) is likely to be high, e.g. from 0.1 to 50 wt %, because the sulphur cement pre-composition is effectively a concentrate of the sulphur plus coupling agent. Conversely, if the sulphur cement pre-composition is combined with filler only to form a sulphur cement, then the weight percentage of the organosilane coupling agent of formula (I) is likely to be lower, e.g. from 0.01 to 1 wt %.

In the sulphur cement pre-composition according to the present invention the weight ratio of sulphur to organosilane coupling agent is at least 1. Preferably, the weight ratio of sulphur to organosilane coupling agent is at least 10, more preferably at least 50.

Suitably, the weight ratio of sulphur to organosilane coupling agent is at most 5000, preferably at most 1000.

Preferably, the weight ratio of sulphur to organosilane coupling agent is in the range of from 10-5000, more preferably in the range of from 50-1000.

In addition, the sulphur cement pre-composition may comprise a sulphur modifier. Typically, the sulphur cement pre-composition may comprise sulphur modifiers in an amount in the range of from 0.1 to 10 wt % based on the weight of sulphur. Such modifiers are known in the art. Examples of such modifiers are aliphatic or aromatic polysulphides or compounds that form polysulphides upon reaction with sulphur. Examples of compounds that form polysulphides are naphthalene or olefinic compounds such as 5 ethylidene-2-norbornene (ENB) or 5 vinyl-2-norbornene (VNB), dicyclopentadiene, limonene or styrene.

The sulphur cement pre-compositions according to the invention may be advantageously produced off-site and used on-site in small volumes. The sulphur cement pre-composition may contain a concentration of the organosilane coupling agent of formula (I) which is higher than the concentration typically used in a process for preparing a sulphur cement product. When used on-site to prepare for instance a sulphur cement product, such a sulphur cement pre-composition may suitably be added in such amounts to an inorganic material that the need for stabilising agent is satisfied. The sulphur cement product may be completed by adding additional sulphur and other ingredients if not sufficiently present in the sulphur cement pre-composition.

The present invention further provides a sulphur cement product, comprising sulphur, a particulate inorganic material and an organosilane coupling agent of formula (I), wherein the weight ratio of sulphur to organosilane coupling agent is at least 1. Examples of sulphur cement products are sulphur cement, sulphur mortar, sulphur concrete and sulphur-extended asphalt. A sulphur cement refers to a composition comprising sulphur or modified sulphur and a filler. Usual sulphur cement fillers are particulate inorganic materials with an average particle size in the range of from 0.1 μm to 0.1 mm. The filler content of sulphur cement may vary widely, but is preferably in the range of from 1 to 50 wt %, based on the total weight of the sulphur cement. Sulphur mortar comprises fine aggregate, typically with particles having an average diameter between 0.1 and 5 mm, for example sand, and does not comprise coarse aggregate. Sulphur concrete comprises coarse aggregate, typically with particles having an average diameter between 5 and 40 mm, and optionally comprises fine aggregate. Sulphur-extended asphalt comprises aggregate and a binder that contains filler and a residual hydrocarbon fraction, wherein part of the binder has been replaced by sulphur, usually modified sulphur.

Preferably, the particulate inorganic material in the sulphur cement product has oxide or hydroxy groups on its surface. Examples of suitable particulate inorganic materials are silica, fly ash, limestone, quartz, iron oxide, alumina, titania, carbon black, gypsum, talc or mica, sand, gravel, rock or metal-silicates. Such metal silicates are for example formed upon heating heavy metal containing sludge in order to immobilise the metals. More preferably the particulate inorganic material is a silica or a silicate. Examples of such silica or silicates are quartz, sand, metal-silicates (e.g. mica).

Sulphur cement product according to the present invention preferably comprises the organosilane coupling agent of formula (I) in the range of from 0.01 to 30 wt %, more preferably of from 0.05 to 10 wt %, based on the weight of the sulphur cement. Sulphur mortar or sulphur concrete preferably comprises the organosilane coupling agent of formula (I) in the range of from 0.001 to 1 wt %, more preferably of from 0.005 to 0.5 wt % and most preferably of from 0.01 to 0.1 wt %, based upon the weight of the sulphur mortar or sulphur concrete.

The present invention yet further provides a process for the preparation of a sulphur cement pre-composition, comprising admixing sulphur with an organosilane coupling agent of formula (I), wherein the weight ratio of sulphur to organosilane coupling agent is at least 1. The organosilane coupling agent of formula (I) may first be dissolved in a small amount of solvent, for example an alcohol or a hydrocarbon, in order to facilitate the admixing with the sulphur. The solvent preferably has a boiling point such that it evaporates during the admixing step.

Preferably, the sulphur and organosilane coupling agent of formula (I) are admixed at a temperature at which sulphur is molten. The temperature at which sulphur is molten is typically above 120° C., preferably in the range of from 120 to 150° C., more preferably in the range of from 125 to 140° C. Mixing at temperatures at which the sulphur is molten may provide a homogeneous distribution of organosilane coupling agent of formula (I) in the sulphur. Preferably the obtained sulphur cement pre-composition is cooled to a temperature at which the sulphur solidifies. The solid sulphur cement pre-composition can be easily stored or transported.

Alternatively the sulphur cement pre-composition of the invention may be prepared, as described above, by combining compounds of formula (II), (III) and (IV) in the presence of molten sulphur.

The invention yet further provides a process for the preparation of a sulphur cement product comprising the steps of:

(a) admixing sulphur with an organosilane coupling agent of formula (I) and with a particulate inorganic material at a temperature at which sulphur is molten to obtain a molten sulphur cement product, and wherein the weight ratio of sulphur to organosilane coupling agent is at least 1; and

(b) solidifying the molten sulphur cement product.

In one embodiment of the process, a sulphur cement product is prepared by admixing in step (a) a sulphur cement pre-composition according to the invention and a particulate inorganic material at a temperature at which sulphur is molten to obtain a molten sulphur cement product. In another embodiment of the process, a sulphur cement product is prepared by admixing in step (a), elemental or modified sulphur, an organosilane coupling agent of formula (I), and a particulate inorganic material, i.e. the sulphur and the organosilane coupling agent of formula (I) are used as individual components rather than as a sulphur cement pre-composition.

In one embodiment of the process, in step (a) an organosilane coupling agent of formula (I) may first be admixed with the particulate inorganic material in a pre-treatment step, and then subsequently the treated particulate inorganic material is admixed with sulphur. The organosilane coupling agent of formula (I) is preferably admixed with the particulate inorganic material by dissolving the organosilane in a small amount of solvent, for example an alcohol or a hydrocarbon, and admixing with the particulate inorganic material. The solvent preferably has a boiling point such that it evaporates during the admixing step.

Step (a) is carried out at a temperature at which sulphur is molten, i.e. typically above 120° C., preferably in the range of from 120 to 150° C., more preferably in the range of from 125 to 140° C.

Optionally further ingredients such as sulphur modifiers may be admixed during step (a). Preferably, all ingredients of the sulphur cement product are admixed at a temperature at which sulphur is liquid.

In step (b) the molten sulphur cement product is solidified by cooling the product to a temperature at which the sulphur solidifies.

Alternatively the sulphur cement product of the invention may be prepared, as described above, by combining compounds of formula (II), (III) and (IV) in the presence of molten sulphur and particulate inorganic material.

The sulphur cement products produced according to the invention are suitable for use in typical sulphur cement product applications. A sulphur cement according to the invention can be combined with aggregate to provide sulphur mortar or sulphur concrete. Sulphur concrete according to the invention can be moulded to provide products such as paving materials and sea defences.

### EXAMPLES

The invention is further illustrated by means of the following non-limiting examples.

### Organosilane Synthesis

5.20 g (0.04 mol) Na₂S.3H₂O (60% Na₂S) and 3.84 g (0.12 mol) sulphur were dissolved in 10 g of water and heated to 70° C. in a round bottomed flask with a condenser and magnetic stirrer. 9.63 g (0.04 mol) chloropropyltriethoxysilane (CPTES), 0.02 mol dichloroalkane and 0.20 g tetrabutylammonium bromide were added and the stirred for 3 hours at 70° C. After stirring, the phases were separated and the products were obtained. Typically, the upper layer comprises the product, and the lower layer comprises dissolved salts. However, when p is greater than or equal to 5, it was found that the product phase forms at the bottom.

Syntheses were carried out using 1,2-dichloropropane and 1,4-dichlorobutane as the dichloroalkane, providing organosilanes having the structures shown below:

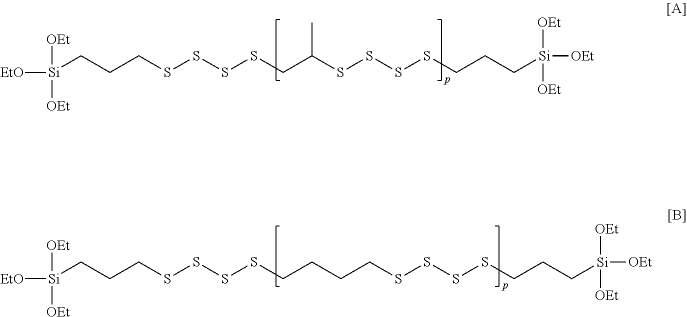

The value of p was determined using NMR analyses. Different ratios of starting materials provided compounds with different values of p.

Five different organosilanes according to the invention and one comparative organosilane were used in further tests:

TABLE 1

| Comparative | Bis(3-triethyoxysilylpropyl) |
|---|---|
| Organosilane 1 | tetrasulphide |
| Organosilane 1 | Structure [A] above with p = 1 |
| Organosilane 2 | Structure [A] above with p = 5 |
| Organosilane 3 | Structure [B] above with p = 1 |
| Organosilane 4 | Structure [B] above with p = 4 |
| Organosilane 5 | Structure [B] above with p = 5 |

### Sulphur Mortar Preparation

Standard sulphur mortar samples were prepared from 50.0 g sulphur, 56.0 g quartz and 94.0 g sand. In a 250 ml tin the sulphur, sand and quartz were mixed and heated by an oil bath with a temperature of 150° C.; this gave a mortar temperature of 130-140° C. Once a homogeneous paste was obtained the organosilane coupling agent was added and the mixture was stirred for another 15 minutes at the same temperature. Subsequently the hot pastes were transferred to preheated silicone molds with 15 holes for 1×1×4 cm³ prisms. The samples were allowed to cool to room temperature and were stored for at least three days before further testing. In each sulphur mortar batch 15 prisms were obtained, of these 15 prisms 5 were immersed in water for 4-5 weeks, where the weight was monitored to evaluate the water intrusion.

### Strength Testing

For strength testing 1×1×4 cm³ prisms were used in a strain controlled three point bending setup with a support span of 30 mm. The strain rate during the measurement was 0.1 mm/min. The maximum exerted force (Fₘₐₓ) and the measured dimensions of the prisms were used to calculate the stress at break σ_{b} using the equation: σ_{b}=3*Fₘₐₓ*L/(2*w*h²), where L is the width of the span (30 mm), w is the width of the prism (˜10 mm) and h is the height of the prism (˜10 mm). For each sulphur mortar batch the strength was calculated from the average strength of five prisms. For measuring the strength of wet samples five other prisms from the same batch were taken.

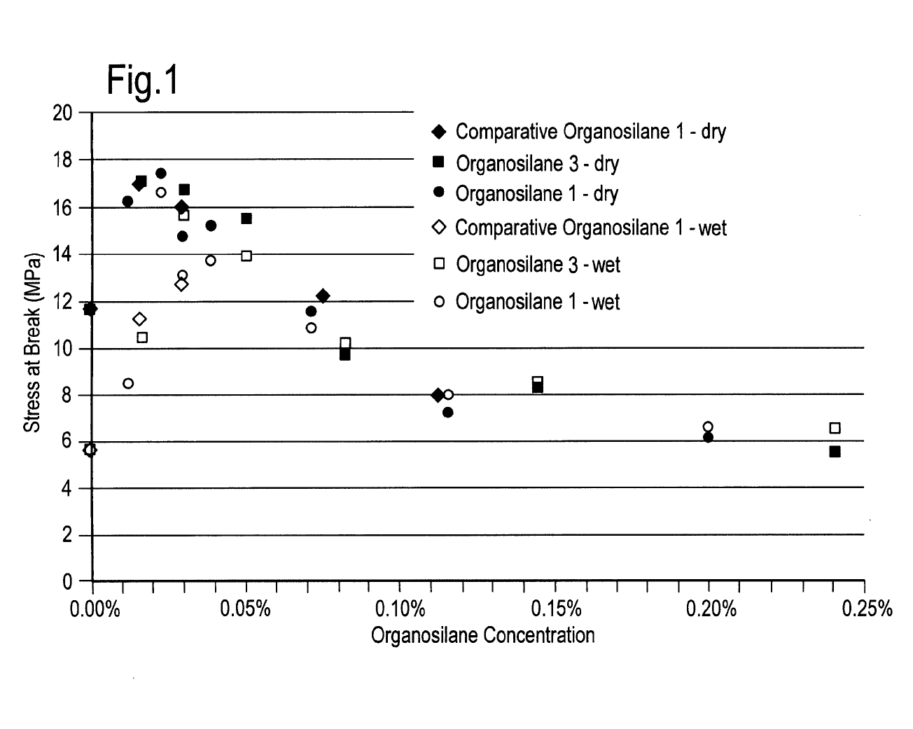

FIG. 1 shows mortar strength results for two different organosilanes of the invention and for comparative organosilane 1. The mortar strengths were similar for the organosilanes of the invention and for the comparative organosilane.

### Water Intrusion Testing

The samples were weighed and placed in demineralised water. The water intrusion was monitored by weighing the samples at several intervals in time. Before weighing the samples were wiped dry with paper towels; after weighing the samples were placed back in the water. For each sulphur mortar batch 2-5 samples were used for water intrusion testing.

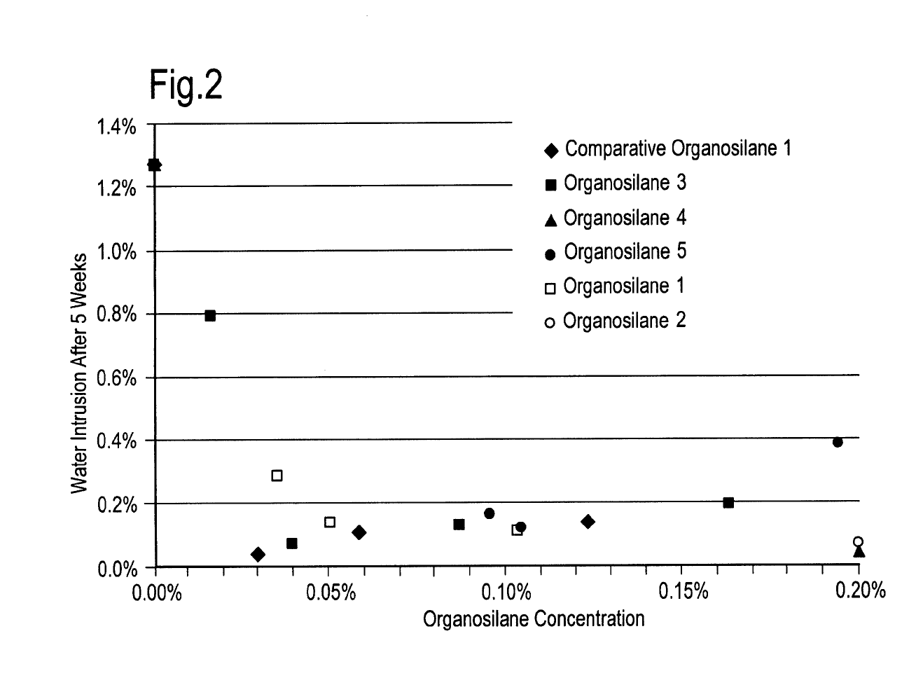

FIG. 2 shows water intrusion results for sulphur mortar samples comprising varying concentrations of the comparative organosilane and the organosilanes according to the invention. The water intrusion results for the mortar samples comprising the organosilanes of the invention were similar to those obtained for the comparative organosilane.

### Effect of Sulphur Concentration

Sulphur mortars were prepared having 20 wt % sulphur and 25 wt % sulphur, but keeping the quartz: sand ratio constant. The organosilane used was Organosilane 3.

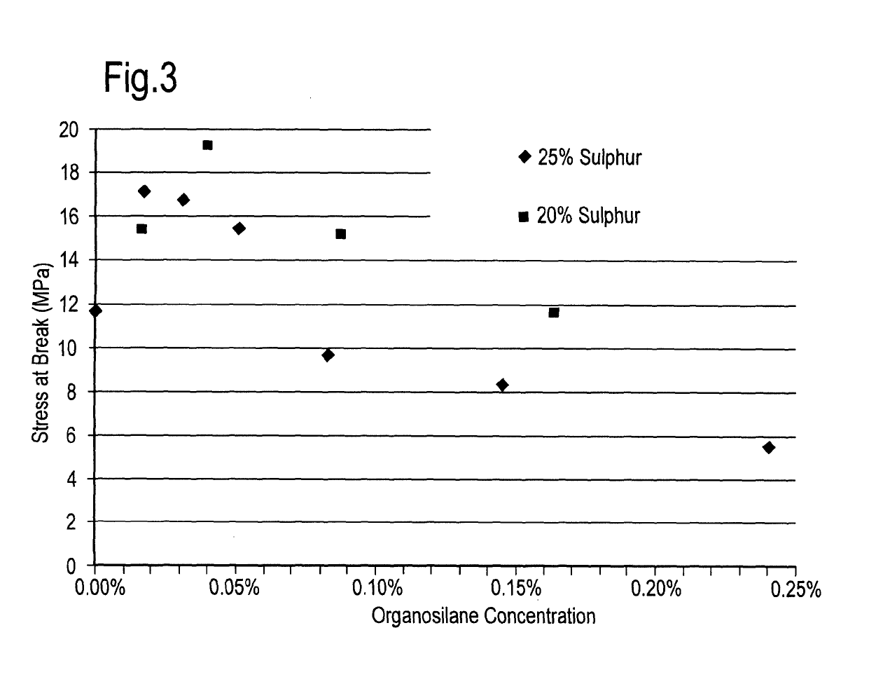

FIG. 3 shows that decreasing the sulphur concentration increases the strength.

The organosilane of the invention is particularly appropriate for reducing the sulphur concentration (and increasing the strength) of sulphur mortar because the flow of the sulphur mortar tends to reduce at lower sulphur concentrations and the organosilane improves the flow properties of the solid. The inventors have observed that the flow of sulphur mortars containing organosilane 3 is better than the flow of sulphur mortars containing an equivalent amount of bis(3-triethyoxysilylpropyl)tetrasulphide. With organosilane 3 it is possible to manufacture sulphur mortars with sulphur content as low as 15 wt %.

1. A sulphur cement pre-composition, comprising sulphur and an organosilane coupling agent of formula (I): 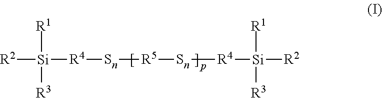
wherein R¹, R² and R³ are independently chosen from alkoxy, acyloxy, aryloxy, alkyl, aryl and halogen, wherein R⁴ is alkyl, wherein n is from 1 to 8, wherein R⁵ is alkyl, alkenyl or aralkyl and wherein p is an integer of at least 1, and wherein the weight ratio of sulphur to organosilane coupling agent is at least 1.

2. A sulphur cement pre-composition according to claim 1, wherein R¹, R² and R³ are all the same and are alkoxy groups.

3. A sulphur cement pre-composition according to claim 1, wherein R⁴ is alkyl.

4. A sulphur cement pre-composition according to claim 1, wherein R⁵ is C₁₋₆ alkyl or C₁₋₆ alkenyl.

5. A sulphur cement pre-composition according claim wherein the weight ratio of sulphur to organosilane coupling agent is at least 10.

6. A sulphur cement pre-composition according to claim 1, wherein the weight ratio of sulphur to organosilane coupling agent is at least 50.

7. A sulphur cement pre-composition according to claim 1, wherein the weight ratio of sulphur to organosilane coupling agent is at most 5000.

8. A sulphur cement pre-composition according to claim 1, wherein the weight ratio of sulphur to organosilane coupling agent is at most 1000.

9. A process for the preparation of a sulphur cement pre-composition, comprising admixing sulphur with an organosilane coupling agent of formula (I): 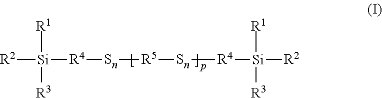
wherein R¹, R² and R³ are independently chosen from alkoxy, acyloxy, aryloxy, alkyl, aryl and halogen, wherein R⁴ is alkyl, wherein n is from 1 to 8, wherein R⁵ is alkyl, alkenyl or aralkyl and wherein p is an integer of at least 1, and wherein the weight ratio of sulphur to organosilane coupling agent is at least 1.

10. A sulphur cement product, comprising sulphur, a particulate inorganic material and an organosilane coupling agent of formula (I): 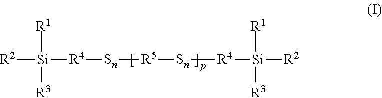
wherein R¹, R² and R³ are independently chosen from alkoxy, acyloxy, aryloxy, alkyl, aryl and halogen, wherein R⁴ is alkyl, wherein n is from 1 to 8, wherein R⁵ is alkyl, alkenyl or aralkyl and wherein p is an integer of at least 1, and wherein the weight ratio of sulphur to organosilane coupling agent is at least 1.

11. A sulphur cement product according to claim 10, wherein the weight ratio of sulphur to organosilane coupling agent is at least 10.

12. A sulphur cement product according to claim 10, wherein the weight ratio of sulphur to organosilane coupling agent is at least 50.

13. A sulphur cement product according to claim 10, wherein the weight ratio of sulphur to organosilane coupling agent is at most 5000.

14. A sulphur cement product according to claim 10, wherein the weight ratio of sulphur to organosilane coupling agent is at most 1000.

15. A process for the preparation of a sulphur cement product comprising the steps of:
(a) admixing sulphur with an organosilane coupling agent of formula (I): 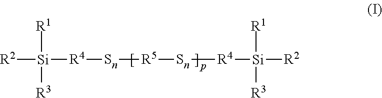
wherein R¹, R² and R³ are independently chosen from alkoxy, acyloxy, aryloxy, alkyl, aryl and halogen, wherein R⁴ is alkyl, wherein n is from 1 to 8, wherein R⁵ is alkyl, alkenyl or aralkyl and wherein p is an integer of at least 1, and with a particulate inorganic material at a temperature at which sulphur is molten to obtain a molten sulphur cement product, and wherein the weight ratio of sulphur to organosilane coupling agent is at least 1; and
(b) solidifying the molten sulphur cement product.
